(19) United States
(12) Patent Application Publication
(10) Pub. No.: US 2014/0173832 A1
(43) Pub. Date: Jun. 26, 2014

(54) MULTI-PURPOSE KITCHEN KNIFE

(71) Applicant: John Jungwon Kim, Los Angeles, CA (US)

(72) Inventor: John Jungwon Kim, Los Angeles, CA (US)

(21) Appl. No.: 13/738,820

(22) Filed: Jan. 10, 2013

(30) Foreign Application Priority Data
Dec. 21, 2012 (KR) 10-2012-0150633

(51) Int. Cl. B26B 11/00; B26B 9/02; B26B 3/02

(52) U.S. Cl. CPC B26B 11/006; B26B 3/02; B26B 9/02
USPC 7/156; 30/353; 30/342

(57) ABSTRACT

A multi-purpose kitchen knife which enables the user, by using only one kitchen knife, to cut or trim various kinds of food materials. Thus, it is not necessary to keep several kitchen utensils in the narrow kitchen space, and consequently it enhances the usefulness of the kitchen space.

### CROSS REFERENCE TO RELATED APPLICATIONS

This application claims priority to Korean Patent Application No. 10-2012-0150633 filed on Dec. 21, 2012, the entirety of which is incorporated herein by reference.

### FIELD OF THE INVENTION

The present disclosure generally relates to a multi-purpose kitchen knife and embodiments thereof. A user can cut vinyl wrap or aluminum foil using this single kitchen knife; the user can press down and use the knife inserting user's hand. It allows the user not only to chop or cut foods such as bulbs, esculent roots, or flesh-meat, but also to slice easily relatively hard foods such as frozen materials; this multi-purpose kitchen knife even enables the user to open bottle caps.

### BACKGROUND OF THE INVENTION

Generally each family and restaurant keeps a knife as a necessity that is used to cut or chop food materials when foods are cooked, and the knife such as this is usually composed of a hilt that the user can grasp, and a blade one side of which is fixed to the hilt.

Moreover, as the top of the blade is formed to be a blunt surface, and the lower end is formed to a sharp edge, the user cuts, chops or slices food materials, while holding the handle of the knife and using the sharp edge.

Since such a kitchen knife is formed only for the usage of cutting or slicing food materials, in fact it is necessary to prepare and make use of several knives apt for each food material, owing to the reality, for example, that there are very diverse kinds of food, and also there are very diverse kinds of materials used for every food.

In other words, the so-called kitchen knives frequently used in kitchen are not very problematic in case of cutting or slicing such food materials as vegetables, but in case of hard frozen foods, the usual knives are of no use for cutting or slicing, so it is necessary to prepare separate knives apt for cutting the frozen foods, because the users must use such knives in order to cut thick frozen foods.

All the more, also in case of esculent roots such as radish or carrot, it is very difficult to cut or slice hard edible roots by means of usual kitchen knives; as a result, when cooking or trimming off edible roots vegetable, cooks or housewives should force hand wrists overly, causing pains in hand wrists.

On the other hand, utensils such as scissors, besides kitchen knives, are kept in the kitchen for cutting the vinyl wrap or aluminum foil, and users employ these utensils in order to cut and remove the vinyl wrap or aluminum foil covering food materials or food containers. Besides, the bottle cap opener, etc., are prepared in the kitchen, so that they can be used at once, if necessary.

Thus, there is the problem that space efficiency for the narrow kitchen is greatly degraded, because not only kitchen knives but also various utensils such as scissors or openers should be kept in a single place.

When examining the former technique, Korean Public Utility Patent 20-2011-0008629 concerns a kitchen knife that has been devised so that on the part of the back of the kitchen knife a protrusion is placed, and a circular arc blades (a hook type) are furnished on both sides of the protrusion; projections in a wavy pattern are formed on the top of the protrusion.

For another example, as Korean Public Patent 10-2013-0129273 a multi-purpose knife for pizza has been devised: it is composed of a handle which can be grasped by hands; a pizza server which is extended as a plate form in front of the handle; a pizza cutting blade alongside of the pizza server in one or both sides of the pizza server; in the central part alongside of the pizza server a sauce squeezing groove is formed which is composed of an open mouth part opened in the front and a closed snagging part in the back; and a cutter of the pickle container cover in an outward protrusion form on the edge of the handle or pizza server.

Although the former technique enables the user to cut various food materials by placing a protrusion on the back of the knife, there is a problem that it is quite useless either for cutting the vinyl wrap or aluminum foil, or for opening bottle caps, except the usage of cutting only food materials.

The latter's former technique, even though it enables the user to cut pizza easily by forming the pizza cutting blade in a wavy pattern, there is a lot of difficulty for it to be used as an the kitchen knife.

The following are additional patent documents that may be relevant to the present disclosure: Republic of Korea Public Utility Patent No. 20-2011-0008629 (Sep. 9, 2012 publicized), Republic of Korea Public Patent No. 10-2012-0129273 (Nov. 28, 2012 Publicized).

### SUMMARY OF THE INVENTION

The purpose of this invention is to offer a multi-purpose kitchen knife that enables the user to cut or chop food materials, by using only one knife, regardless of kind of food material.

Another purpose of this invention is to offer a multi-purpose knife that enables the user to open any bottle's cap no matter it is a crown bottle cap or a PET bottle cap.

Another purpose of this invention is to offer a multi-purpose knife that enables the user to cut and remove with ease vacuum packing, ordinary vinyl or vinyl wrap, and aluminum foil that pack food materials, foods, or meat, especially vacuum packing for fish or seafoods.

Another purpose of this invention is to offer a multi-purpose knife that fixes a chopping section to mince such as garlic or ginger, and prevents this chopping section from breaking away from the kitchen knife.

This invention manifests a multi-purpose kitchen knife, and it features hollowed Inserting Part (11) for inserting fingers in the inside alongside the length, First Cutting Blade (12) that is fabricated in the wavy pattern alongside the length so that it can cut hard food materials such as frozen materials and bones in meat, chop meat or slice a laver-wrapped rice roll or bread, Second Cutting Blade (13) in the lower tip is fabricated alongside the length so that it can cut soft materials such as vegetables, Body (10) from which Hilt (14) is extended towards the rear side, First Oblique Cutting Blade (21) that extends from First Cutting Blade (12), Second Oblique Cutting Blade (22) that extends from First Oblique Cutting Blade (21), Blade part for Wrap Cutting (20) that forms a gradual gorge, starting from the front of Body (10), towards the inside direction of Body (10),

Fixing Section (30) that features, in the inside, Fitting Part (31) into which is fitted Hilt (14) that extends towards the rear of Body (10),
Handle (40) that features, alongside the length in the inside, Connecting Hole (41) where the exterior of Fixing Section (30) is inserted and connected. Since this invention enables the user, by using only one kitchen knife, to cut or trim various kinds of food materials, it is not necessary to keep several kitchen utensils in the narrow kitchen space, and consequently it enhances the usefulness of the kitchen space.

### BRIEF DESCRIPTION OF THE DRAWINGS

FIG. 1 is an oblique view of the present multi-purpose kitchen knife.

FIG. 2 is a structural front view of the present multi-purpose kitchen knife as an example.

FIG. 3 is a structural side view of the present multi-purpose kitchen knife as an example.

FIG. 4 is a structural cross section that displays main components for the structure of the present multi-purpose kitchen knife.

FIG. 5 is an enlarged drawing for Section A of FIG. 4.

FIG. 6 is an enlarged drawing for Section B of FIG. 4.

FIG. 7 is a structural drawing that displays, omitting portions, the connecting relation among Handle of the knife and Fixing Section, and Hilt.

FIG. 8 is a structural front view of the present multi-purpose kitchen knife as another example.

FIG. 9 is a structural front view of the present multi-purpose kitchen knife as another example.

FIG. 10 is a structural front view of the present multi-purpose kitchen knife as another example.

### DETAILED DESCRIPTION OF THE INVENTION

To achieve the aforementioned purpose, this invention of a multi-purpose kitchen knife is composed of hollowed Inserting Part, inside alongside of the length direction, where fingers enter; on the top First Cutting Blade that is fabricated in a wavy pattern alongside of the length direction to cut hard food materials such as frozen foods, bones in meat, laver-wrapped rice rolls and bread, or to chop meat; in the lower end Second Cutting Blade that is fabricated alongside of the length direction to cut soft materials such as vegetables; Body from whose rear Hilt extends; First Oblique Cutting Blade that extends from aforementioned First Cutting Blade; and Second Oblique Cutting Blade that extends from aforementioned Second Oblique Cutting Blade; Wrap Cutting Blade formed in a gradual gorge toward the inside of Body starting from the front; Fixing Section that includes Inserting Part inside where Hilt extending toward the rear of aforementioned Body is inserted; and Handle in whose inside Connecting Hole is formed alongside of the length direction where an outside of Fixing Section is inserted and connected.

Further, Crown Cap Opener to open the crown cap is furnished in one side of Inserting Part hollowed in Body.

Further, aforementioned Crown Cap Opener is composed of Connecting Piece that extends from aforementioned Inserting Part, and sticks to the lower end of the crown cap, and of Arc Piece that extends from aforementioned Connecting Piece, and sticks to the top of the crown cap.

Further, in aforementioned Inserting Part, PET Bottle Cap Opener is furnished additionally that extends from Inserting Part, and is formed in a wavy pattern so as to grasp the outside of the PET bottle cap.

Further, in aforementioned Handle, Chopping Section is furnished additionally that is fitted into Connecting Hole of Handle, and whose Chopping Part is exposed toward the rear of Handle so as to chop produce such as garlic or ginger.

Further, Hilt that is fitted into Fitting Part of aforementioned Fixing Section is fabricated so as to interpenetrate Fitting Part of aforementioned Fixing Section so that Tip of Hilt should be exposed from aforementioned Fitting Part, and Projections are furnished additionally on Tip of aforementioned Hilt; aforementioned Chopping Section is composed of Fixing Part that is fitted into Connecting Hole of aforementioned Handle, and furnished with Fixing Grooves where Projections made on Tip of aforementioned Hilt is fitted and fixed, and of Chopping Part that extends from aforementioned Fixing Part, and is exposed toward the rear of aforementioned Handle.

Further, between aforementioned First Cutting Blade and aforementioned Body, First Widening Surfaces that widen increasingly starting from both sides of aforementioned First Cutting Blade toward Body, and First Narrowing Surfaces that narrow increasingly starting from both tips of aforementioned First Widening Surfaces toward Body are fabricated in extension so as to prevent materials cut by First Cutting Blade from sticking to aforementioned Body.

Further, between aforementioned Second Cutting Blade and aforementioned Body, Second Widening Surfaces that widen increasingly starting from both sides of aforementioned Second Cutting Blade toward Body, and Second Narrowing Surfaces that narrow increasingly starting from both tips of aforementioned Second Widening Surfaces toward Body are fabricated in extension so as to prevent materials cut by Second Cutting Blade from sticking to aforementioned Body.

Since this invention enables the user to cut or trim various food materials by using only one kitchen knife, the efficiency of space in the kitchen area is enhanced, for it is not necessary to keep several kitchen utensils in the narrow kitchen.

Further, the user can expect versatile utility from this invention, because not only the user can cut or trim food materials, but also the user can open crown bottle caps or PET bottle caps by using this kitchen knife.

Further, this invention can lighten the weight of the entire kitchen knife, because Inserting Part is hollowed out in Body where fingers enter, and work efficiency is greatly enhanced for chopping such as onion, garlic and meat, because the user can insert fingers and press down Body when using it.

Further, this invention enables the user to prevent cut food materials from sticking to Body, while the user is cutting or slicing food materials, making use of First Cutting Blade and Second Cutting Blade.

Further, this invention enables the user to remove the vinyl wrap that envelops food materials or packing containers that hold food materials or foods with ease, and moreover it enables the user to cut aluminum foils with ease.

In the following, other purposes besides those abovementioned and characteristics of this invention will manifest itself through the explanation about the example of implementation with reference to the attached figures. Unless defined otherwise, the meanings of all the terms used here, including technical or scientific terms, are same as those generally understood by people who possess common knowledge in the technical field where this invention belongs. Generally the terms such as defined in dictionaries should be interpreted as having the identical meanings with those in the context of the related technology, and unless defied clearly in this patent application, they should not be interpreted unusually or excessively.

In the following, the multi-purpose kitchen knife is explained in detail according to the example of implementation of this invention with reference to the attached figures.

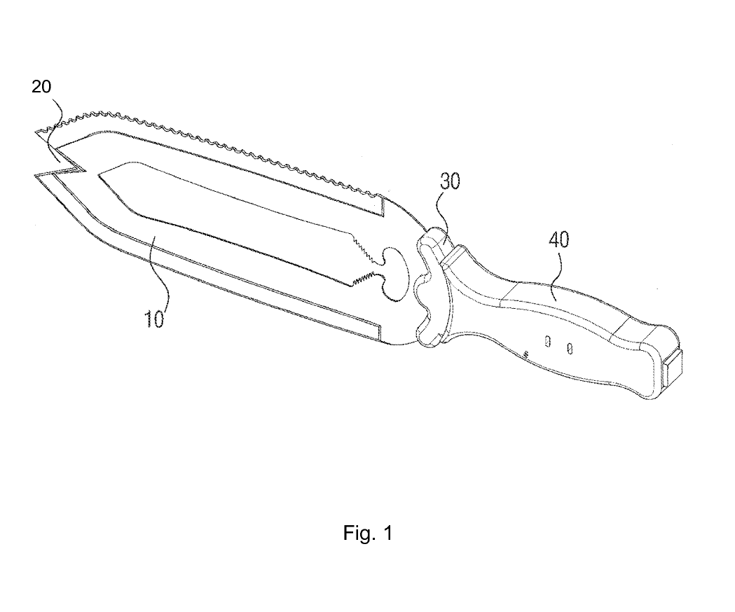

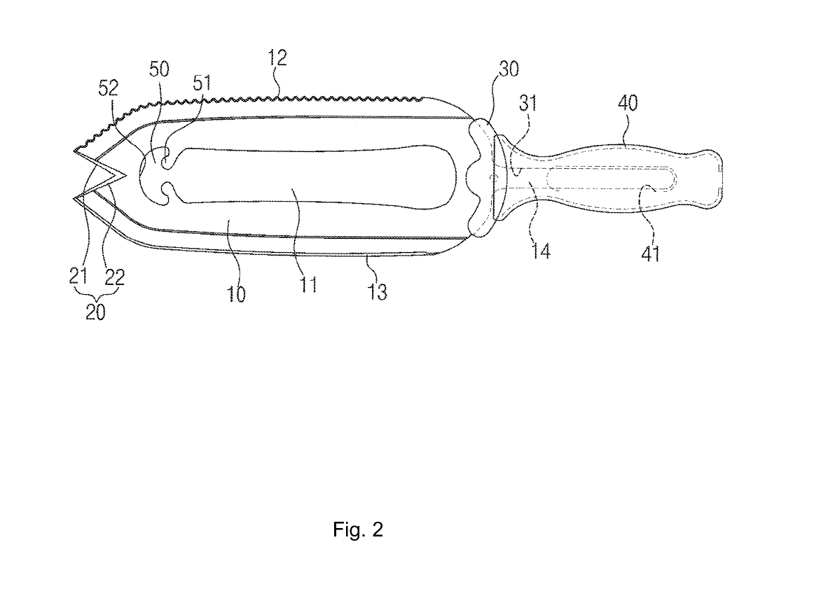

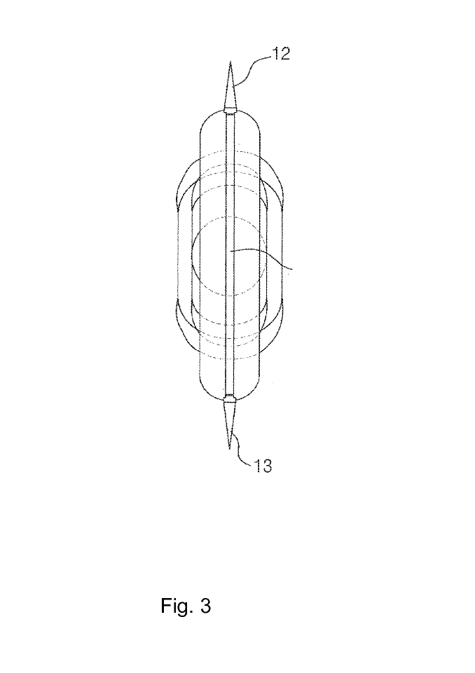

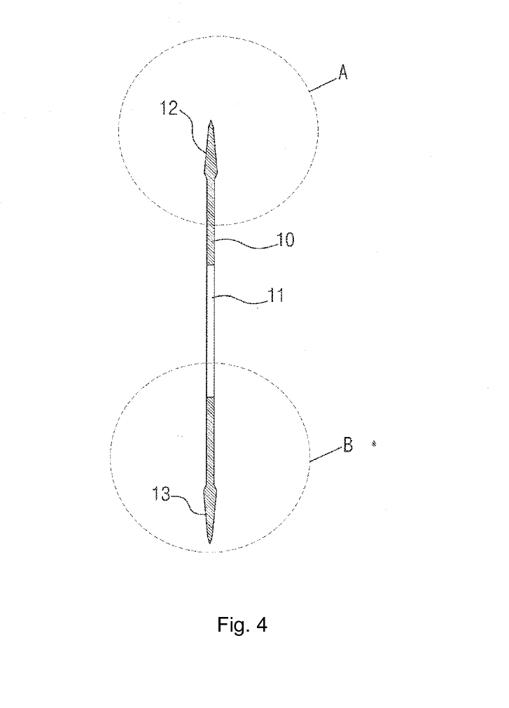

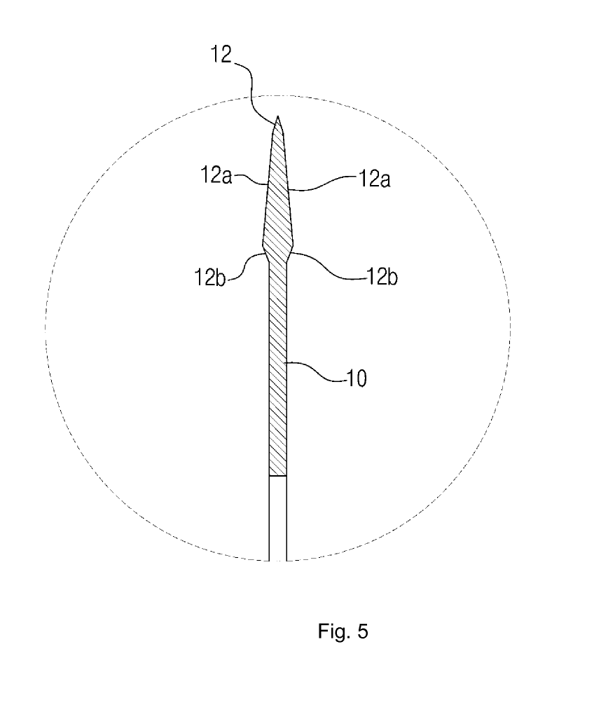

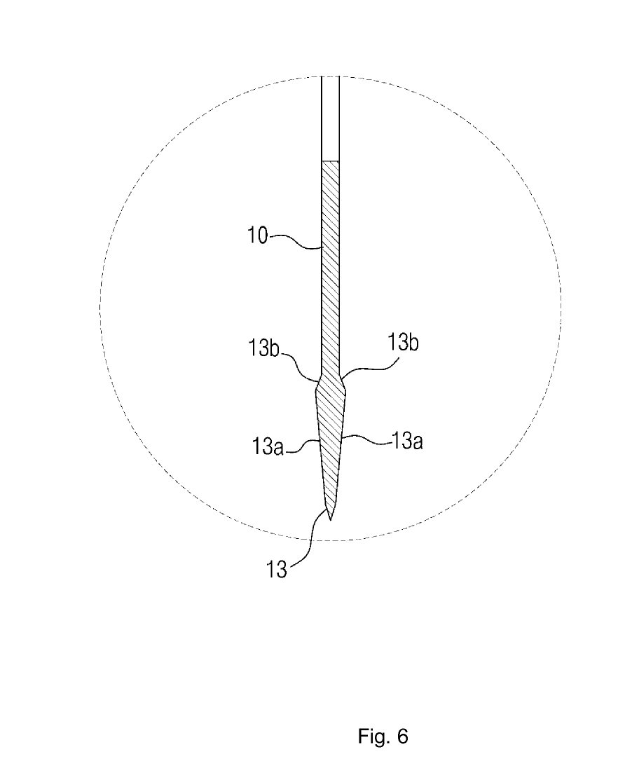

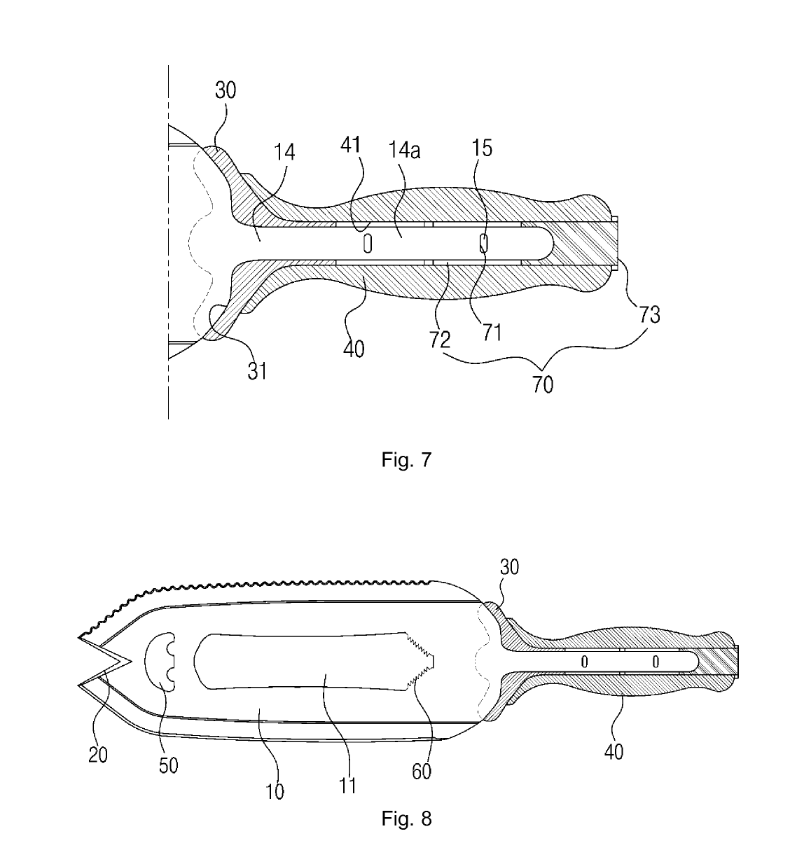

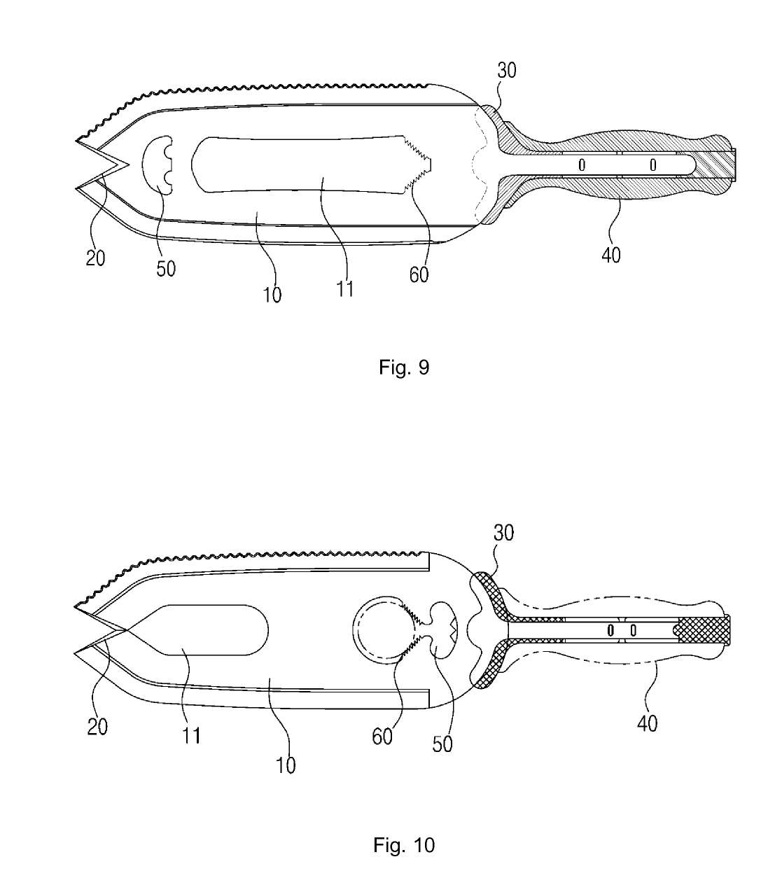

As illustrated in FIGS. 1 and 2, this invention of a multi-purpose of a kitchen knife is composed of Body (10), Wrap Cutting Part (20), Fixing Section (30), and Handle (40).

Aforementioned Body (10) is fabricated in the way that, in its inside, Inserting Part (11) is hollowed alongside of the length direction where fingers enter; on the top First Cutting Blade (12) is fabricated in a wavy pattern alongside of the length to cut hard food materials such as frozen foods, bones in meat, to chop meat, or to cut laver-wrapped rice rolls and bread; and in the lower end Second Cutting Blade (13) is fabricated alongside of the length direction to cut soft materials such as vegetables, and Hilt (14) is extended toward the rear.

Although it is explained that the first cutting blade (12) is formed in a wavy pattern, it needs not be confined to a wavy pattern, and a serriform pattern is permissible likewise. When the user minces, for example, garlic, vegetables or meat, the aforementioned inserting part (11) allows the user to apply pressure on the minced materials by inserting fingers into the aforementioned inserting part (11) and pressing down the inserting part (11) by the user's palm.

All the more, when mincing meat, the user can easily mince materials by using the body (1) as an axle after inserting user's hand into the inserting part (11).

All the more, since the inserting part (11) is hollowed alongside the body (10), the weight of the body (10) can be considerably lessened, and the material to manufacture the body (10) of this invention of a multi-purpose knife can be minimized for the economic benefit owing to the hollowed space of the inserting part (11).

The aforementioned first cutting blade (12) is formed in a wavy (or serriform) pattern, and it is usually used to cut or sever hard materials such as frozen foods or frozen materials.

The aforementioned second cutting blade (13) is composed of a generally used kitchen knife, and it is usually used to cut or sever foods other than hard materials such as frozen foods or frozen materials.

Thus, the user can use one kitchen knife to cut or sever various kinds of cooking materials, because everybody (10) is provided with the first cutting blade (12) in a wavy pattern and the second cutting blade in an ordinary pattern respectively.

The aforementioned wrap-cutting part (20) is provided with the first oblique cutting blade (21) extending to the aforementioned first cutting blade (12) and the second oblique cutting blade (22) extending from the aforementioned first cutting blade (21), and it is formed in a gradual gorge from the front of the body (10) into the interior of the body (10).

At this time, since the aforementioned first oblique cutting blade (21) and the aforementioned second oblique cutting blade (22) are formed in a gradual gorge form towards the body (10) as illustrated in FIG. 1, a warp or aluminum foil positioned between the first oblique cutting blade (21) and the second oblique cutting blade (22) is cut, when the user, while grasping the aforementioned handle (40), places the wrap or aluminum foil between the first oblique cutting blade (21) and the second oblique cutting blade (22), and pushes the handle as it stands.

Therefore, when cutting a wrap covering a package containing food materials or foods, the user can easily cut the wrap after puncturing the wrap if the user pushes the handle as it stands, after puncturing the wrap utilizing the frontal part of the oblique cutting blade, either of the first oblique cutting blade (21) or the second oblique cutting blade (22), while holding the holding the handle (40).

In the inner side of the aforementioned fixing section (30), a fitting part (31) is formed into which is fitted the hilt (14) that extends towards the rear of the body (10).

At this time, the front of the fixing section (30) is formed to cover a portion of the rear of the body (10), and the rear of the body (10) adheres closely to the fixing section (30), and the close adhesion and fixation is attained between the body (10) and the fixing section (30).

In the inner side of the handle (40), alongside the length, is formed a connecting hole (41) where the exterior part of the fixing section (30) is inserted and connected.

Since the exterior part of the aforementioned fixing section (30) and the connecting hole (41) of the aforementioned handle (40) are fitted by means of a forced fitting method so as to tighten up the handle (40) and the fixing section (30), the fixing section (30) and the handle (40) can be connected as well by using pieces or volts, if necessary.

Since this invention of the multi-purpose kitchen knife structured in the aforementioned way enables the user to cut and trim various food materials, it is not necessary to keep, in the narrow kitchen space, several kitchen utensil used to slice, cut or trim various kinds of food materials, consequently enhancing the usefulness of the kitchen space.

All the more, in this invention is fabricated a crown cap opener to open a crown cap in one side of the inserting part (11) that is hollowed in the Body (10).

As it is commonly known, a crown cap designates a bottle cap with wavy projections around the brim part, and it blocks the bottle mouth; since the crown cap opener allows the user to open the crown cap easily, a separate opener is not necessary.

At this time, the crown cap opener is composed of a connecting piece (51) which extends from Inserting Part (11) and adheres to the lower tip of the crown cap, and of Arc Piece (52) which extends from Connecting Piece (51) and adheres to the upper tip of the crown cap.

Therefore, when the user wants to open the crown cap with the crown cap opener (50), by uplifting Body (10) from the bottle covered with the crown cap the user can easily open the crown cap using Crown Cap Opener (50), after sticking Arc Piece (52) to the upper tip of the crown cap while sticking Connecting Piece (51) to the lower tip of the crown cap which covers the bottle mouth.

All the more, this invention is furnished further, in aforementioned Inserting Part (11), with PET Bottle Cap Opener, which extends from Inserting Part (11), and is formed in the wavy pattern in order to grasp the surface of PET bottle cap.

As it is commonly known, PET bottle cap designates a cap which covers the mouth of PET bottle which contains various beverages or liquid foods, and which is made of PET material; the PET bottle cap is installed in the way that it is opened by turning it around.

As a result, after placing PET bottle cap inside PET Bottle Cap Opener (60), the user can open the PET bottle cap easily by turning Body (10) by means of Handle (40).

In this case, since PET Bottle Cap Opener (60) is composed of two wavy sides formed in a slant wavy pattern, it suffices to place PET bottle cap between two wavy sides, and it can open any PET bottle cap regardless of size.

Thus, this invention of the multi-purpose kitchen knife can open any bottle cap including all plastic or metal bottle caps, spiraled or press-formed metal bottle caps.

All the more, this invention is further equipped, in Handle (40), with Chopping Section (70) that is inserted into Inserting Hole (41), and whose chopping part is exposed towards the rear of Handle (40), so that it can chop produce such as garlic or ginger, and meat.

At this time, Hilt (14) which is inserted into Fitting Part (31) of Fixing Section (30) interpenetrates Fitting Part (3) of Fixing Section (30) and installed in the way that Tip (14a) of Hilt (40) is exposed out of Fitting Part (31), and fixing projections are furnished additionally, and aforementioned Chopping Section (70) is composed of Fixing Part (72) which is fitted into Connecting Hole (41) of Handle (40), and which is furnished with Fixing Groove (71) into which Fixing Projections (15) made on Tip (14a) of Hilt (14) is fitted and fixed, and of Chopping Section (73) which extends out of Fixing Part (72) and is exposed towards the rear of Handle (40).

Consequently, since Chopping Section (70) can be fixed to Handle (40), it can prevented the problems caused by the fact that Chopping section (70) is separated or loosened while the user is chopping garlic, ginger or meat.

This invention of the multi-purpose kitchen knife is equipped with First Cutting Blade (12), First Widening Surfaces (12a), and First narrowing Surfaces (12b) so as to prevent materials cut by First Cutting Blade (12) from sticking to Body (100, First Widening Surfaces (12a) widen increasingly towards the direction of Body (10) starting from both sides of First Cutting Blade (12), and First Narrowing Surfaces (12b) are extended from the tip of First Widening Surfaces (12a), and formed to narrow increasingly towards Body (10).

Thus, the user can prevent chopped food materials from sticking to Body (10), while cutting or slicing food materials using First Cutting Blade (12) or Second Cutting Blade (13) owing to First Widening Surfaces (12a) or Second Widening Surfaces (13a).

Especially, when cutting materials higher than Body (10) such as a large radish, watermelon, pumpkin or sweet pumpkin and when more than half of the blade penetrates into the cut material, the body of the knife is nipped in the material and doses not move, because the area of the contacting surfaces of both the cut material and the body of the knife in case of the usual knife, hence the elderly people or feeble wives used to have difficulty while cutting food material higher than the body of the knife, but this invention can solve the problems of the former kitchen knives through linear contact with food materials sliced by First Widening Surfaces (12a) and Second Widening Surfaces (13a).

Furthermore, when slicing radish or carrot, it avoids the inconvenience of removing the sticking materials every time the sliced materials stick to the surfaces of the blade; First Widening Surfaces (12a) and Second Widening Surfaces (13a) cause the sliced materials to fall immediately off Body (10), sliced by aforementioned First Cutting Surfaces (12) and Second cutting Blade (13) and prevent sticking to Body (10).

In the above, this invention has been explained by way of specific factors such as concrete components, certain operating examples, and figures, but it simply aims to be helpful for general understanding of this invention. This invention is not limited to the operating examples, and anyone who possesses general knowledge in the field this invention belongs to is capable of modification and changing this equipment.

Therefore, the ideas of this invention should not be limited to the operating examples explained here, and not only the extent of this patent application specified in the following, but also everything that is equal to the extent of this patent application or modified with the equal value should be considered to belong to the ideas of this invention.

The following is listing with a description of each of the reference numbers indicate in the present figures:

| | |
|---|---|
| 10: Body | 11: Inserting Part |
| 12: First Cutting Blade | 12a: First Widening Surface |
| 12b: First Narrowing Surface | 13: Second Cutting Blade |
| 13a: Second Widening Surface | 13b: Second Narrowing |
| | Surface |
| 14: Hilt | 15: Fixing Projection |
| 20: Blade Part for Wrap Cutting | 21: First Oblique Cutting |
| | Blade |
| 22: Second Oblique Cutting Blade | 30: Fixing Section |
| 31: Fitting Part | 40: Handle |
| 41: Connecting Hole | 50: Crown Cap Opener |
| 51: Connecting Piece | 52: Arc Piece |
| 71: Fixing Groove | 72: Fixing Part |
| 73: Chopping Part | |

What is claimed is:

1. A multi-purpose kitchen knife comprising:
An inside which is hollowed for Inserting Part (11) where fingers enter, and in its upper tip First Cutting Blade (12) is fabricated in the wavy pattern alongside the length so as to slice hard food materials including frozen materials or bones of meat, to chop meat or cut garlic or bread; in the lower tip second Cutting Blade is fabricated alongside the length so as to cut soft materials including vegetables, Body (10) extends to Hilt (14) toward the rear side;
First Oblique Cutting Blade (21) is fabricated to extend from First Cutting Blade (12), and Second Oblique Blade (22) is fabricated that extends from First Oblique Cutting Blade (21), and Blade Part for Wrap Cutting (20) so as to form a gradual gorge starting from the front of Body (10) toward the interior side of Body (10);
Fitting Section (30) is fabricated in the inside so that Fitting Part (31), into which is inserted Hilt (14) that extends toward the rear side of Body (10), is formed in the inside of Fitting Section (30);
Handle (40) is fabricated so that in its inside, alongside the length, is formed Connecting Hole (41) where the exterior part of the Fixing Section (30) is inserted and connected.

2. The multi-purpose kitchen knife of claim 1, wherein the multi-purpose kitchen knife includes additionally a Crown Cap Opener (50) that opens the crown cap; Crown cap Opener (40) is fabricated, in one side of hollowed Inserting Part (11) in Body (10), by interpenetrating of Body (10).

3. The multi-purpose kitchen knife of claim 1, wherein the multi-purpose kitchen knife includes the Crown Cap Opener (50) is composed of Connecting Piece (51) and Arc Piece (52); Connecting Piece (51) extends from the Inserting Part (11), and sticks to the lower tip of the crown cap, and Arc Piece (52) extends from the Connecting Piece (51), and sticks to the upper tip of the crown cap.

4. The multi-purpose kitchen knife of claim 1, wherein the multi-purpose kitchen knife include a PET Bottle Cap Opener (60) additionally fabricated in the Inserting Part (11); the PET Bottle Cap Opener extends from Inserting Part 911), and is formed in the wavy pattern so as to grasp the exterior of PET bottle cap.

5. The multi-purpose kitchen knife of claim 1, wherein the multi-purpose kitchen knife includes a Chopping section (70) which is fabricated additionally in the Handle (40), and Chopping section (70) is fitted into Connecting Hole (41), and is exposed towards the rear side of Handle (40) so as to chop produce including garlic or ginger.

6. The multi-purpose kitchen knife of claim 1, wherein the multi-purpose kitchen knife includes a Hilt (14) that fits into Fitting Part (31) of the Fixing Section (30) and is fabricated so that Tip (14a) of Hilt (14) is exposed from the Fitting Part (31) after interpenetrating Fitting Part (31) of the Fixing Section (30);
and in Tip (14a) of Hilt (14), Fixing Projection (15) is furnished additionally;
and the Chopping Section (70) is composed of Fixing Part (72) and Chopping Part (73); Fixing Part (72) that is fitted into Connecting Hole (41) of handle (40) is equipped with Fixing Groove (71) into which is fast fitted Fixing Projection (15) formed on Tip (14a) of Hilt (14), and Chopping Part (73) that extends from Fixing Part (72) is exposed towards the rear side of Handle (40).

7. The multi-purpose kitchen knife of claim 1, between First Cutting Blade (12) and Body (10), in order to prevent the materials cut by first Cutting Blade (12) from sticking to Body (10), First Widening Surface (12a) that widens increasingly towards Body (10, starting from both sides of First Cutting Blade (12), First Narrowing Surface (12b) that narrows increasingly towards the body side, starting from the tip of First Widening Surfaces (12a) are extended and formed.

8. The multi-purpose kitchen knife of claim 1, wherein between Second Cutting Blade (13) and Body (10), in order to prevent the materials cut by Second Cutting Blade (12) from sticking to Body (10), Second Widening Surface (13a) that widens increasingly towards Body (10), starting from both sides of Second Cutting Blade (13), Second Narrowing Surface (12b) that narrows increasingly towards the body side, starting from the tip of Second Widening Surfaces (12a) are extended and formed.
